(19) United States
(12) Patent Application Publication
(10) Pub. No.: US 2002/0049916 A1
(43) Pub. Date: Apr. 25, 2002

(54) Password issuing method, data transmission method, password issuing device, program for executing password issuing method, recording medium storing same, program for executing data transmission method, and recording medium storing same

(76) Inventors: Iwao Nozaki, Wakayama-shi (JP); Yoshinari Marumoto, Wakayama-shi (JP)

Correspondence Address: NIXON & VANDERHYE P.C., 8th Floor, 1100 North Glebe Road, Arlington, VA, 22201-4714, US

(21) Appl. No.: 09/984,627

(22) Filed: Oct. 30, 2001

(30) Foreign Application Priority Data
May 2, 2000 (JP) 2000-133371

(51) Int. Cl. H04L 9/32

(52) U.S. Cl. 713/202

(57) ABSTRACT

A host computer determines if it is a time to reissue a password for use in an authentication check of a computer of a client, and if so, performs a process of updating the password. In the password to be reissued, included is specific data reflecting the existing state of the computer of the client with regard to data communication. As a result, the host computer can be prevented from having access from disqualified computer of a client or illegal access from a third person with stolen password.

### FIELD OF THE INVENTION

The present invention relates to a password issuing method, a data transmission method, a password issuing device, a program for executing the password issuing method, a recording medium storing the same, a program for executing the data transmission method, and a recording medium storing the same, which realize an enhanced security of a data transmission system so that upon transmitting data from an original server to a terminal equipment on a side of a user via an intermediate server, etc., in response to a request for transmitting data from the terminal equipment, data can be prevented from being stolen at any stage of a transmission pass of the data, and data transmission fees can be collected accurately.

### BACKGROUND OF THE INVENTION

In recent years, with saltatory advanced communication technology and enhanced communication infrastructure, variety of data are exchanged over communication lines of various types and kinds. For instance, in the Internet which has a growing demand worldwide, variety of data can be exchanged including not only text data base but also music data, image data, etc.

For example, in the field of communication karaoke, a pay music data transmission system is in widespread use. In this system, a reproduction terminal provided with a communication facility is installed at each of the stores provided throughout the country, and is connected to a main computer over a private communication line so that music data can be transmitted to each store via the reproduction terminal. According to this system, music data as requested are transmitted to the reproduction terminal by downloading the data over the private communication line. The foregoing pay music data transmission system is therefore advantageous in that a new piece of music can be added on the instant.

In recent years, the following communication system is also in widespread use. That is, program data for games, music data, video data, etc., are transmitted to a terminal equipment installed, for example, in a convenience store, so that a general user can record data obtained from the terminal equipment onto a recording medium of a type as desired. According to this communication system, variety of data become available for a general user, and he/she can record data as desired with a payment of a predetermined fee to the terminal equipment. A part of the collected fee is paid to the owner of copyright, i.e., a provider of these data. In this specification, the foregoing communication system is referred to as a leased circuit business model.

In the leased circuit business model, a transmission system is established only by a copyright administrator who owns original data and a transmitter who made a contract with the copyright administrator. Namely, with a copyright administrator's permission who owns original data, the transmitter installs an original server for storing therein the copyrighted data. Further, terminal equipments are provided at various locations, and are connected to the original server. Namely, by centralizing the management of the data transmission system at single transmitter of data, it is possible to keep track of payment and collection of fees accurately.

According to the leased circuit business model, however, in an event that a computer which functions as a transmitting server is knocked at the transmitter which centralizes the management of the transmission route up to the general user, the transmission of data may be ceased. Further, in an event that certain data is too heavily demanded (for example, on the first sale date of new piece of music of a favored artist, etc.), at the music data provider, etc., it is likely to have access exceeding a permissible level of the transmitting server, and this may cause a substantial delay in data transfer, or even cause a knocked server, etc.

In recent years, with advanced computer network, such communication system may be established, wherein the copyright administrator makes contracts with a plurality of transmitters, and permits these transmitters to exchange data among them. In this communication system, data can be transmitted from the terminal equipment of the transmission requesting end of the data over a communication pathway which permits the data to be received in the most efficient way. In this system, the communication pathway of data can be changed according to the existing state of communications, etc., without being fixed.

With the enhanced Internet, however, it becomes very likely that many third persons intervene on the communication pathway, which may result in various problems, for example, illegal copy of data, wiretap in the communication pathway of data, tampering with data, etc., or still more complicated communication pathway which makes the management of the communication pathway to be practically impossible, etc.

In response, the following data transmission method may be adopted, wherein ID (identification) and password are issued from the computer at the receiving end of data (receiver computer) to the computer at the transmitting end of data (transmitter computer), and when the receiver computer requests the transmitter computer to transmit data, the receiver computer sends its ID and password to the transmitter computer to be authenticated that the receiver computer is a registered computer authorized to be connected to the transmitter computer, and the transmitter computer transmits data only to the authenticated receiver computer.

The foregoing authentication check is generally performed before authorizing a computer to access the server at a provider when connected to the Internet, etc.

Then, the receiver computer requests the transmitter computer to update ID and password at an appropriate timing and receives new ID and password as issued. In this way, the steel prevention measure of the ID and password can be established, and enhanced security can therefore be achieved.

For the data transmission, detailed contracts are made beforehand between the transmitter and the receiver, for example, on use fees of data. Specifically, in the case of the music data, the ceiling on the permissible number of times of reproduction is set between the above two parties, which sets the maximum permissible number of receiving the data by the receiver computer of the third person per piece of music. Then, the data are transmitted from the transmitter to the receiver in pursuance of the terms of the contract.

However, the data transmission method adopting the foregoing authentication method presents the following problems.

Firstly, the foregoing scheme of reissuing ID and password is adopted for the purpose of enhancing the security measure on the side of the receiver computer, and this does not provide any solution for the security problem on the side of the transmitter computer. Therefore, the transmitter computer cannot determine if the ID and password for which authentication is requested are transmitted from the registered receiver computer or the third computer with stolen ID, and such problem that the third computer keeps receiving data illegally until the transmitter computer notices that ID and password have been stolen are likely to occur.

Secondary, when reissuing ID and password, the transmitter computer does not perform a special check with regard to the contract performance of the receiver computer except for the authentication check to be performed before connecting the receiver computer to the transmitter computer. For example, even if the use fees of data has not been settled, the transmitter computer may keep issuing ID and password, resulting in a delay in discovery of a problem in contract performance.

Thirdly, it is desirable that the terms of the contract set between the transmitter computer and the receiver computer can be modified automatically according to the existing state of use and the state of performance of the contract, etc. In the data transmission method currently used, however, it is difficult to reflect modification in the terms of the contract immediately. Specifically, according to the currently used data transmission method, whenever the terms of the contracts are to be modified, for example, to raise or reduce the use fees of data, or to increase or decrease the ceiling on the permissible number of times of reproduction per piece of music in the case of music data, or to stop the use of data, etc., both the transmitter and the receiver need to go through the formalities.

In the foregoing system of exchanging data among a plurality of transmitters, a transmitter which receives data directly from the original server is referred to as a secondary transmitter, and a transmitter which receives data transferred from the secondary transmitter is referred to as a tertiary transmitter. Here, the secondary transmitter may transmit data to the terminal equipment, or to the tertiary transmitter. In the foregoing system, as contracted transmitters increase in the lower level, such as quartic, quintic transmitters, the above-discussed first through third problems turn even more grave.

Particularly, in the case where the data to be transmitted are copyrighted, the foregoing system of exchanging data among the plurality of transmitters presents the problem of inducing the copyright administrator to have insecure feeling, and it is therefore difficult to place this system into practical applications.

Further, when establishing a transmission system which permits exchange of data among a plurality of transmitters on the Internet, the factors which induce the copyright administrator to have insecure feeling would increase.

### SUMMARY OF THE INVENTION

It is therefore an object of the present invention to overcome the above and other drawbacks of the prior art and to provide a password issuing method, a data transmission method, a password issuing device, a program for executing the password issuing method, a recording medium storing same, a program for executing the data transmission method, and a recording medium storing same, that realize enhanced security by the structure wherein a transmitter computer is capable of determining reissuing time of an ID and a password of a receiver computer, and issuing the ID and the password only to a receiver computer which satisfies standard condition, and that permit contract terms set between the transmitter computer and the receiver computer to be modified mainly by the transmitter computer according to the existing state of use and the performance of contract on the side of the receiver computer.

In order to achieve the above object, the password issuing method of the present invention for issuing a password by a host computer, which is to be transmitted from a computer of a client to the host computer to be authenticated by the host computer upon initiation of communications, is characterized by comprising the steps of:

i) monitoring by the host computer if it is a time for reissuing the password; and

ii) if it is determined in the step i) that it is the time for reissuing the password, carrying out a process of updating the password.

According to the foregoing structure, even without a request for reissuing a password or an ID from the computer of the client, the password can be changed by the host computer at appropriate time intervals. Therefore, after the password is changed at the host computer, the computer of the client can never be authenticated by the host computer unless receiving the password as changed.

Therefore, even if the third person makes an attempt to steel the password, since the password has been changed already at the host computer, such problem that the third person keeps receiving data illegally can be prevented. As a result, enhanced security measures can be realized for both the host computer and the computer of the client.

Here, the shorter is the time interval for changing passwords, the more enhanced is the security measure; however, the time intervals should be set in consideration of a balance between the security level and the burden on the system.

The length of the interval for changing passwords may vary in many ways depending on the nature and frequency of the communication, and other than the structure of changing passwords in the predetermined elapsed of time, it may be arranged so as to change passwords whenever some modification is made in terms of contract with regard to data transmission, or a request for reissuing a password is received from the client, or upon detecting an illegal access.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a flowchart illustrating a process of issuing a password according to the password issuing method of the present invention;

FIG. 2 is a block diagram illustrating an example structure of a password issuing device of the present invention;

FIG. 3 is a block diagram illustrating an example of a computer of a client in accordance with the present invention;

FIG. 4 is an explanatory view which gives an idea of an connected structure of a data transmission system for reissuing a password reflecting user data as necessary; and

FIG. 5 is an explanatory view schematically illustrating a network structure of the data transmission system of the present invention.

### DESCRIPTION OF THE PREFERRED EMBODIMENT

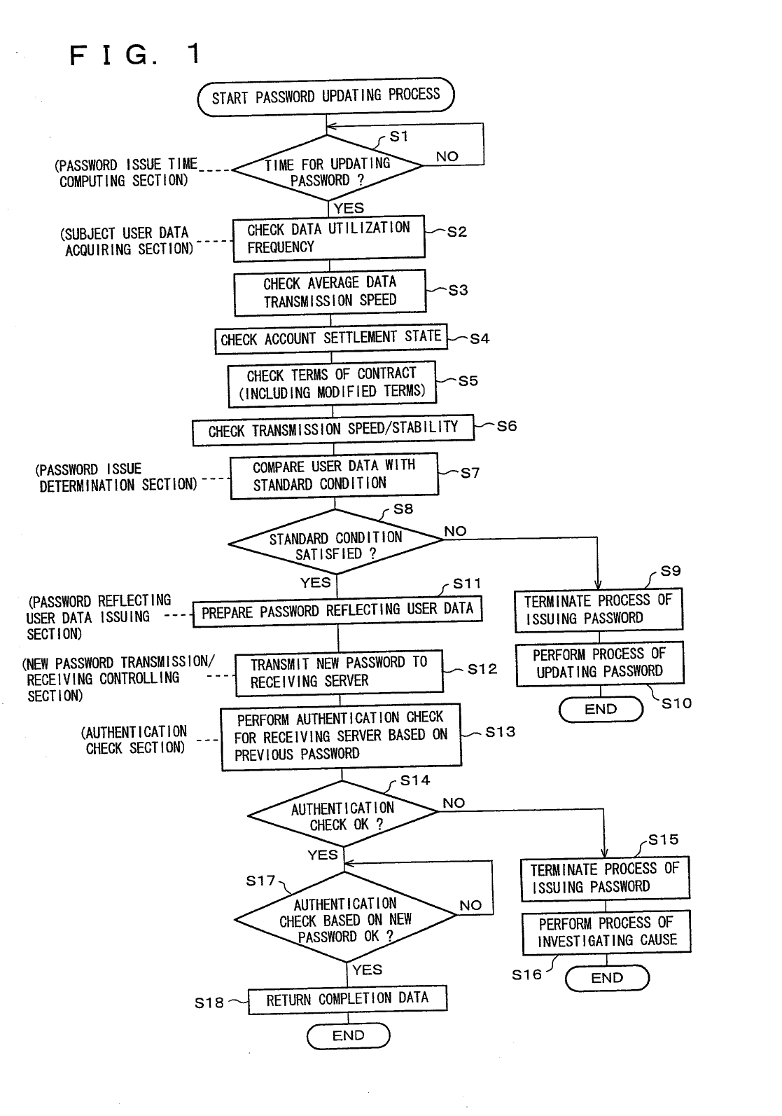

The following description will discuss one embodiment of the present invention with reference to FIG. 1 to FIG. 5.

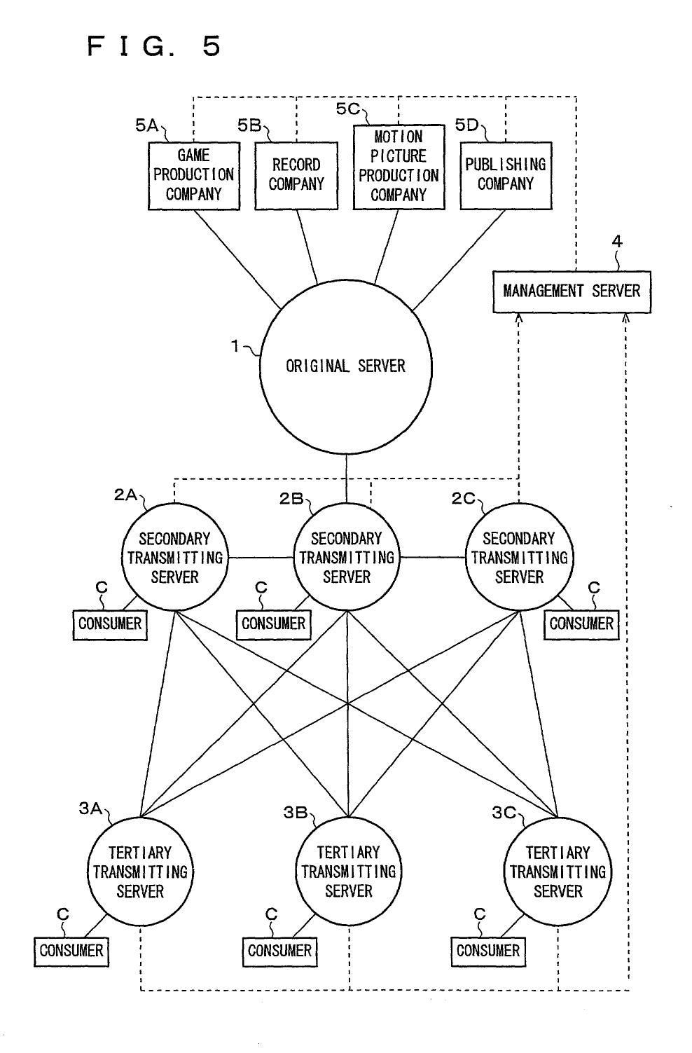

FIG. 5 is an explanatory view schematically illustrating the structure of a data transmission system in accordance with the embodiment of the present invention. As illustrated in FIG. 5, the data transmission system of the present embodiment includes an original server 1, secondary transmitting servers 2A, 2B and 2C, and tertiary transmitting servers 3A, 3B and 3C. The original server 1 stores therein original data such as program data for games, music data, image data and data on publications, etc. The secondary transmitting servers 2A, 2B and 2C serve as workstations for transferring variety of data received from the original server 1 to other computers. Similarly, the tertiary transmitting servers 3A, 3B and 3C serve as workstations for transferring variety of data received from the secondary transmitting servers 2A, 2B and 2C to other computers.

It should be noted here that the foregoing transmission system of the present embodiment may include, in practice, a large number of secondary and tertiary transmitting servers, or may include servers of lower level than the tertiary transmitting servers such as quartic transmitting server, quintic transmitting servers, etc. The structure including a plurality of original servers is also applicable to the data transmission system of the present invention.

The above-explained other computers which serve as receiving ends of variety of data may be other transmitting servers or terminal equipments without being equipped with the function of transmitting data to other computers.

As illustrated in FIG. 5, the original server 1 indicates a server computer which stores therein the above-explained original data and an original server manager which manages the server computer, under the contract with such copyright administrator as a game production company 5A, a record company 5B, a motion picture production company 5C and a publishing company 5D. In this original server 1, stored are digital encoded original data or data to be transmitted which have been converted into the transmission data format based on the original data.

The secondary transmitting servers 2A, 2B and 2C indicate server computers connected to the original server 1 over communication lines, and the secondary transmitters which manage the server computers respectively. The secondary transmitting servers 2A, 2B and 2C are connected to each other over the communication lines. These secondary transmitting servers 2A, 2B and 2C are confirmed to be authorized to connect the original server 1 as being contracted with the original server manager by sending their IDs and passwords to the original server 1. Then, the secondary transmitting servers 2A, 2B and 2C thus authenticated are permitted to download the original data or data to be transmitted stored in the original server 1 through communication lines.

The secondary transmitting servers 2A, 2B and 2C are also mutually connected over the communication lines. These secondary transmitting servers 2A, 2B and 2C are confirmed to have mutual agreements with regard to the data transmission by transmitting ID and password from a secondary transmitting server of a receiving end of data to a secondary transmitting server of a transmitting end of data. Then, the secondary transmitting servers thus authenticated are permitted to exchange each other the data they own respectively.

Further, each of the secondary transmitting servers 2A, 2B and 2C can sell the data it owns to a consumer C. Here, how the consumer C actually purchases the data as desired from the secondary transmitting server of the owner of the subject data is not particularly limited; however, it may be arranged such that the consumer C who wishes to purchase the data comes over an installation place of a terminal equipment, such as a convenience store, a game center, etc., to record the data obtained from the terminal equipment onto a recording medium such as a magnetic disk, an optical disk, a magneto-optical disk, a magnetic tape, a magnetic memory, etc., and then purchases the recording medium having recorded thereon the subject data as desired at the place of installation of the terminal equipment.

The tertiary transmitting servers 3A, 3B and 3C indicate server computers connected to the secondary transmitting servers 2A, 2B and 2C over communication lines and a tertiary transmitter which manages the server computers. These tertiary transmitting servers 3A, 3B and 3C are confirmed to be authorized to connect to the secondary transmitting servers 2A, 2B and 2C as being contracted with the secondary transmitter by sending ID and password to an arbitrary secondary transmitting server. Then, the tertiary transmitting servers 3A, 3B and 3C thus authenticated are permitted to download the original data or data to be transmitted stored in the secondary transmitting servers through communication lines.

Further, each of the tertiary transmitting servers 3A, 3B and 3C can sell data to the consumer C. Here, how the consumer C actually purchases the data as desired from the tertiary transmitting server of the owner of the subject data is not particularly limited; however, it may be arranged such that the consumer C who wishes to purchase the data comes over an installation place of a terminal equipment such as a convenience store, a game center, etc., to record the data obtained from the terminal equipment onto a recording medium, and then purchases the recording medium having recorded thereon the subject data as desired at the place of installation of the terminal equipment as in the above-mentioned case of the secondary transmitting servers 2A, 2B and 2C.

The tertiary transmitting servers 3A, 3B and 3C adopted in the example illustrated in FIG. 5, serve as terminal equipments which do not perform transmission of data. It may be arranged, however, that the respective tertiary transmitting servers 3A, 3B and 3C are mutually connected over communication lines, so that the data owned by respective tertiary transmitting servers 3A, 3B and 3C can be exchanged in pursuance of the terms of the contract.

As illustrated in FIG. 5, the data transmission system in accordance with the present invention is a management server 4 separately provided from the original server and the nth order transmitting server. The management server 4 is connected to the secondary transmitting servers 2A, 2B and 2C and the tertiary transmitting servers 3A, 3B and 3C, and receive history data issued from these servers at a time of selling the data. The history data as collected in the management server 4 is transmitted to the game production company 5A, the record company 5B, the motion picture production company 5C and the publishing company 5D, whereby each copyright administrator recognizes the sales conditions such as an amount of sales, a volume of sales, etc., with regard to the copyrighted data they own.

The characteristic structures of the data transmission system illustrated in FIG. 5 lie in its ID and password issuing scheme, particularly in the password issuing scheme, and in the structure of the device of executing such method, which are to be sent from a receiving end of data to a transmitting end of the data upon initiation of communications, for example, between any of the secondary transmitting servers 2A, 2B and 2C and the original server 1, or between any of the tertiary transmitting servers 3A, 3B and 3C and any of the secondary transmitting servers 2A, 2B and 2C, or between any two of the nth order transmitting servers.

Namely, according to the data transmission system of the present invention, when the receiver computer requests the transmitter computer to reissue password, in addition to the generally used password reissuing scheme of reissuing a password as updated by the transmitting server computer, the following process is performed. That is, even without a request for reissuing a password from the receiver computer, the transmitting server computer monitors if it is a time for reissuing a password, and if so, the process of reissuing the password is performed.

In the password issuing scheme of the present embodiment, a password is changed at predetermined intervals. The length of the interval may depend on the nature and frequency of the communication, and, for example, the length of the interval may be set based on date, week, month, etc. It may be also arranged such that the password is changed whenever some modification is made on contract set between the transmitter and receiver on the user side.

The contract may be modified, for example, when the terms of contract set between the transmitter and the receiver (user) need to be modified, such as the case of reducing or increasing the use fees of data as the utilization frequency of specific data by the receiver become more than or less than the predetermined number, or the case where the copyright administrator wishes to terminate the contract made with any one of the nth order transmitting servers, or to change the use fees of data, or the permissible number of times of transferring the data to other computers, etc., according to the amount sold of data obtained from the management server 4.

The transmitting server computer stores therein accumulated record data on issuing password including at least \mathring{1} computers that issues or reissues password, \mathring{2} the computers that receive passwords as issued or reissued, \mathring{3} issue or reissue date and time of passwords, and \mathring{4} terms of the contract at the time of issuing or reissuing passwords, etc.

Further, the above record data is transmitted from the transmitting server computer to the computer of the management server 4 when updating the record data or at predetermined intervals, so that the computer of the management server 4 is also capable of storing accumulated record data on issuing password for each of the nth transmitting servers.

The password includes the specific data indicative of terms of contract with regard to the data transmission set between the transmitter and the receiver (user). Further, in the specific data, the user data indicative of the existing state of the user with regard to the data transmission is reflected.

First, the content of the user data to be reflected in the password will be explained in detail.

The user data firstly includes discount application ranking data regarding the use fees of data, the ceiling for the permissible transmission number of times of data. The discount application ranking is derived from the receiving number of times the data is received by the receiving user (data utilization frequency of data), basic contract content regarding the fixed discount rate of the data used, the average transmission speed. Namely, for the user who uses the data frequently, a large discount rate is issued in pursuance of the terms of the contract, or for the user of high average communication rate, a larger discount rate is offered as the time the communication line is occupied by such user is short. The foregoing discount application ranking is one example of the accounting condition to be applied to the client.

The content of the basic contract is determined on the side of the copyright administrator or the management server 4 in consideration of the amount sold or the transmission speed of the receiving server, and the resulting content of the basic contract is transmitted to the corresponding transmitting server from the management server 4. The data on frequency of using data and average transmission speed may be stored in the communication server, and receives from the management server 4.

Secondly, the user data includes classification data for the subject data. The classification data for the subject data indicates the data specifying the kind and range of available data based on the basic content of the contract. For example, in the case of music data, the classification data for the subject data indicates the data specifying an available combination of record company as the source of the data to be transmitted, the category of music such as pops, Japanese ballad, film music, jazz, rock, etc., or the data specifying the name of a piece of music, etc. The foregoing classification data for the subject data is one example of the condition on the classification of data that can be supplied to the client.

Thirdly, the user data includes the data on the data indicative of the ceiling as to the permissible number of times of using data. The data indicative of the ceiling as to the permissible number of times of using data indicates the data specifying the ceiling as to the permissible number of times of transferring data to other computers (permitted number of times of reproduction) as determined based on the basic terms of the contract. For example, the music data for a certain name of a piece of music, which is permitted to be transferred to other computer up to 100 times, the maximum permissible number of times of utilization of this music data is 100. The foregoing maximum permissible number of times of utilization is one example of the condition on the restricted utilization of data that can be supplied to the client.

Other than the user data, the champaign data (PR champaign) data may be reflected in the password. The PR champaign data indicates data indicative of that a special price is set for the use fees of specific data for a predetermined campaign period. The foregoing PR campaign data is also one example of the accounting condition to be applied to the client as in the discount application ranking.

Thereafter, the method of obtaining discount application ranking will be explained in detail.

Firstly, for example, the basic contract content is divided into three ranks “a”, “b” and “c”, wherein “a” is indicative of 0% discount rate, “b” is indicative of 5% discount rate and “c” is indicative of 10% discount rate.

Next, points are allocated for the number of times of using data such as 0 point if the number of times used is less than 100 times, 1 point for the range of from 100 to 499 times, 2 points for the range of from 500 times to 999 times, and 3 points for the range of 1000 times or more.

Next, in order to determine the average transmission speed in consideration of an occurrence number of times of a communication error, points are allocated according to the condition, for example, as follows: 3 points for very good condition, 1 point for good condition, 0 point for normal condition, −1 point for bad condition and −3 points for very bad condition.

Then, after obtaining the data indicative of the existing state of the user with regard to the data transmission in the below-explained manner, the existing state of the user is evaluated. For example, assuming that for the secondary transmitting server 2A, the results on the tertiary transmitting server 3B indicates the basic contract of b, the frequency of using data of 120 times, and a very low transmission speed. Then, the discount rate is 5% for the basic contract term b, 1 point for the number of times of using the data, and −3 points for the average transmission speed. Therefore, the discount rate is adjusted to be 5+1+(−3)=3 (%). As a result, for the secondary transmitting server 2A, the tertiary transmitting server 3B is classified into the discount application ranking “3”.

Next, the classification data of subject data will be explained more specifically. For example, the record company 5B illustrated in FIG. 5 is constituted by three record companies 5B₁, 5B₂ and 5B₃ which are the suppliers of the music data of mutually different categories. In this case, the example of the classification data of the subject data is numeral data in combination with record companies of suppliers.

Namely, numbers are allocated in combination with the record companies of supply end of data, such as 5B₁→1, (5B₁, 5B₂)→2, (5B₁, 5B₃)→3, (5B₁, 5B₂, 5B₃)→4, 5B₂→5, (5B₂, 5B₃)→6, 5B₃→7, . . . Therefore, for example, in the case where the original server 1 allows the secondary transmitting server 2C for the transmission of music data from the record companies 5B₁ and 5B₂, the classification data of subject data is 2.

Other than the above, the structure wherein each of the record companies 5B₁, 5B₂ and 5B₃ possesses a list of program numbers of music data, and a number indicative of a range of program numbers in the list may be adopted as the classification data of the subject data. For example, a number “1” is allocated for program numbers of 1 to 100 of the record company 5B₁, a number “2” for program numbers of 101 to 200 of the record company 5B₁, . . . a number “10” for program numbers of 1 to 100 of the record company 5B₂, and so on.

Next, the PR campaign data will be explained in more details. For example, in the case where a discount rate of certain data is to be set to 5 percent in the period of from 3 to 6 months after the first sale date of the subject data, the champaign data is indicated by 3M-6M05. Here, assuming that header data to be added at the leading end of the subject data contains ID data specifying the data, and further this ID data contains the data indicative of the first sale date of the subject data.

On the other hand, in the case where subject data is general music data available from the record company 5B₁, and a discount rate of the subject data is to be set to 5 percent, the subject data is indicated by Scorp05 using a symbol (S, for example) of the record company 5B₁.

The foregoing discount rate may be used other than defining the discount rage of use fees of data, for example, in increasing the maximum permissible number of utilization, i.e., the ceiling on the number of times of transferring data to other computers. For example, assuming that a contact is made between the original server 1 and the secondary transmitting server 2C that the music data of the record company 5B₁ can be transmitted from the original server 1 to the secondary transmitting server 2c up to 50 times per piece of music data. Here, if the general discount rate of the music data of the record company 5B₁ is to be set to 5 percent, the maximum permissible number of times of utilization is computed as 50+50×0.05=52.5 (times), and is rounded up to 53 (times).

The user data and PR champaign data thus prepared may be reflected in a password in the following manner.

(1) A basic password is prepared by random numbers (AAAx001N, for example);

(2) A discount application ranking “3”, a classification data of subject data of “2” and the maximum permissible number of times of utilization of “53” are obtained for user data;

(3) Scorp05 is set for the PR campaign data;

(4) Data “3n2n53nScorp05” composed of the user data and the PR campaign data is prepared for the data to be incorporated in the password; and

(5) A password reflecting the user data “AAAx3n2n53nScorp05001N” is prepared.

The password reflecting the user data adopted in the above example is a simple combination; however, for securing, it is preferable to encrypt in some way the data to be reflected in the password. For example, after converting 3n2n53nScorp05 into xt0001mwA12vv utilizing the encryption, the basic password may be combined with the xt0001mwA12vv thus encrypted to obtain AAAxxt0001mwA12vv001N.

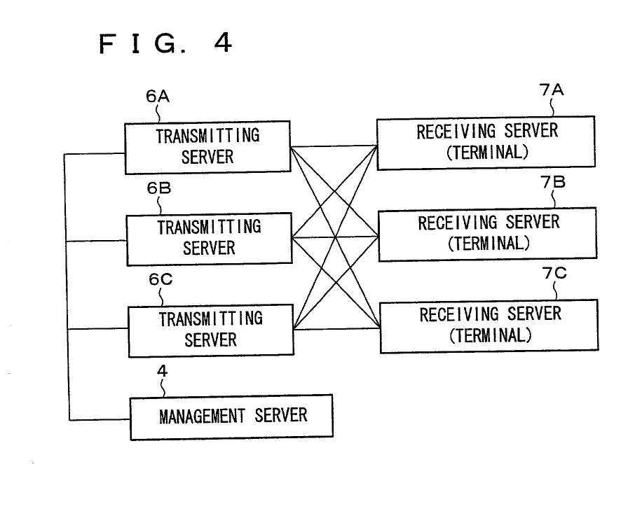

FIG. 4 illustrates a connected structure of the data transmission system in the case of reissuing a password reflecting the user data as necessary from a server at a transmitting end of data to a server at a receiving end of data. Hereinafter, the server at the transmitting end of data is referred to as a transmitting server, while the server at the receiving end of data, that sells data to a consumer is referred to as a receiving server.

For example, the transmitting server 6A monitors if it is a time for reissuing a password reflecting user data with respect to each of the receiving servers 7A to 7C. If so, the transmitting server 6A reissues mutually different new passwords reflecting user data with respect to the respective receiving servers 7A to 7C.

For example, in the case of receiving PR campaign data from the management server 4, a new password incorporating the PR champaign data is reissued. Other transmitting servers 6B and 6C are the same as the above transmitting server 6A for the above structure, and thus each of the receiving servers 7A to 7C receives a different password as reissued that includes a discount application ranking, the classification data of campaign data, and maximum permissible number of times of reutilization.

As to the user data to be reflected in the password (discount application ranking, classification data of subject data, maximum permissible number of reutilization etc.,) , the following structures may be adopted alone or in combination: (i) the structure wherein the user data is computed by the transmitting server 6A, and (ii) the structure wherein the existing state of each of the servers 6A to 6C and 7A to 7C regarding the data transmission is supplied from the management server 4 at which the existing states of respective servers 6A to 6C and 7A to 7C with regard to the data transmission are centralized to the transmitting servers 6A to 6C. Which of the above two structures (i) and (ii) is to be adopted, or both are to be adopted in combination be determined based on the easiness in the management of the management server 4, or an accuracy in the settlement of the use fees of data with respect to the copyright administrator. Here, the transmitting servers 6A to 6C may be arranged so as to receive from the management server 4 an instruction to cease the data transmission with respect to any one of the receiving servers 7A to 7C.

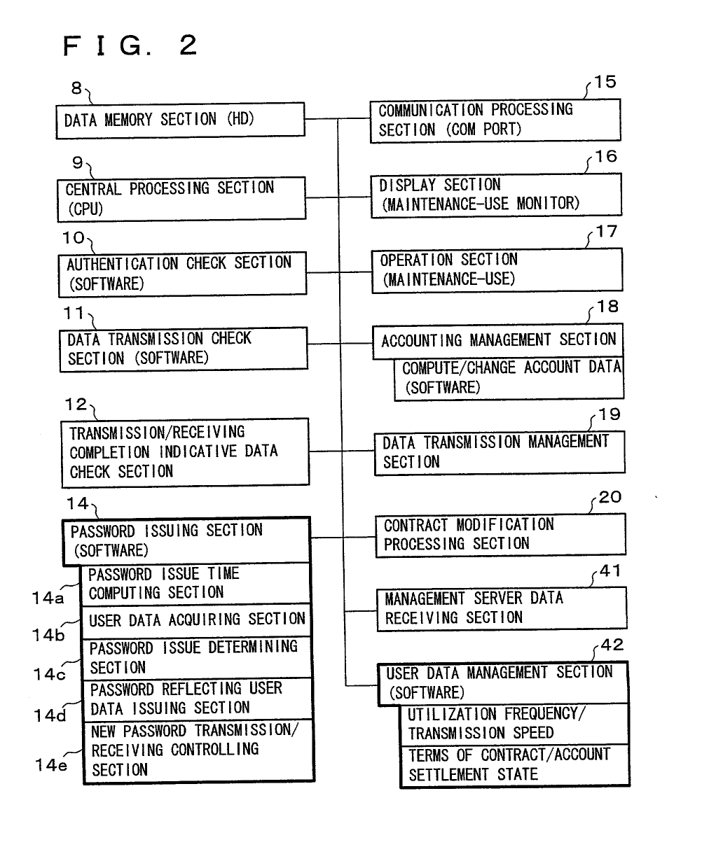

Next, the structure of the transmitting servers 6A to 6C corresponding to the password issuing device of the present invention will be explained. FIG. 2 is a block diagram illustrating schematic structures of the transmitting servers 6A to 6C. FIG. 2 shows the arrangement where the transmitting servers 6A to 6C are constituted by servers of PC (Personal Computer) base.

As illustrated in FIG. 2, each of the transmitting servers 6A to 6C includes a data memory section 8, a central processing section 9, an authentication check section 10, a data transmission check section 11, a transmission/receiving completion indicative data check section 12, a password issuing section 14, a communication processing section 15, a display section 16, an operation section 17, an accounting management section 18, a data transmission management section 19, a contact modification processing section 20, a management server data receiving section 41 and a user data management section 42.

In the example structure shown in FIG. 2, all the sections are connected in the same way. In practice; however, some sections are connected in hardware configuration via various buses and interfaces, etc., and the other sections are connected in software configurations by the linkage on a control/processing program. In the following explanations given for each configuration, transmitting servers 6A to 6C are referred to simply as a transmitting server.

The data memory section 8 is constituted by memory means such as a hard disk (HD) device. The data memory section 8 stores therein data to be transmitted, data indicative of the existing state of the receiving server with regard to the data transmission (such as utilization frequency, transmission speed, basic terms of contract, account settlement state, etc.), or various other management data with regard to transmission. In this hard disk device, or another hard disk device, stored are OS or various programs or data required for the operation of the transmitting server, and the hard disk device serves as a recording medium of the present invention.

The central processing section 9 is constituted by an arithmetic processing section such as a CPU (Central Processing Unit), and performs various arithmetic processing within the transmitting server. Although not shown, RAM (Random Access Memory), etc., required for performing various arithmetic processes may be provided.

The communication processing section 15 serves as an interface with a computer provided in the outside of the transmitting server, and a specific COM port is provided for the computer which constitutes the transmitting server. The network interface is not particularly specified, and, for example, Ethernet, FDDI (Fiber Distributed Data Interface), ISDN (Integrated Services Digital Network), ATM (Asynchronous Transfer Mode), etc., may be adopted.

The display section 16 is constituted by various display monitors such as CRT (Cathode Ray Tube), LCD (Liquid Crystal Display) , etc. The operation section 17 is constituted by an input device such as a keyboard, a mouse, etc. The display section 16 and the operation section 17 perform maintenance operations such as checking operation state of the transmitting server, modifying the processing operation, etc.

The above-explained data memory section 8, the central processing section 9, the communication processing section 15, the display section 16 and the operation section 17 constitute a hardware block of the transmitting server. On the other hand, the below-explained authentication check section 10, the data transmission check section 11, the transmission/receiving completion indicative data check section 12, the accounting management section 14, the password issuing section 14, the accounting management section 18, the data transmission management section 19, the contract modification processing section 20, the management server data receiving section 41, and the user data management section 42 constitute a software block in the transmitting server.

The authentication check section 10 is a block for performing an authentication check of the receiving server of a requesting end of specific data. When a request for access is made from the receiving server to the transmitting server, the authentication check section 10 performs a checking of the ID and the password of the receiving server. Then, the receiving server permits to access only the ID and password which passes the checking.

The data transmission check section 11 checks if the specific data or reproduction number of times subjected to transmission request from the receiving server coincides with the transmission data stored in the transmitting server. In other words, the data transmission check section 11 is a block for checking if the transmitting server is capable of responding to the transmission request from the receiving server appropriately. If it is determined that the transmission is not permitted, that would be transmitted to the receiving server.

The transmission/receiving completion indicative data check section 12 is a block for checking if the data has been transmitted to the receiving server properly when data is transmitted from the transmitting server to the receiving server. Specifically, after the data is transmitted from the transmitting server, it is checked if the transmission and receiving of data is completed properly by detecting if a signal indicative of a completion of the receipt of data from the receiving server has been received.

Here, in an event that an error occurred when transmitting and receiving, if no error is detected in the transmitting server, it is determined that the receiving server has some problem, and although not shown in FIG. 2, the error data is recorded in the data memory section 8, and the data is transmitted to the management server 4. As a result, for example, in the case where the receiving server is an independent terminal without any operator, a failure occurred in the terminal equipment can be informed to the management server 4 on the instant.

The password issuing section 14 is a characteristic block of the present invention for issuing password for respective receiving servers which have data transmission contract, and reissues the password reflecting user data as necessary. Further, the password issuing section 14 is divided into the functional blocks of a password issue time computing section 14a (reissuing time computing section), a subject user data acquiring section 14b, a password issue determining section 14c, a password reflecting user data issuing section 14d (password issuing section), a new password transmission/receiving controlling section 14e.

The password issue time computing section 14a checks by the user data management section 42, intervals for reissuing password for each receiving server, the utilization frequency (number of times of transmitting data) for each receiving server as recorded in the data memory section 8. The password issue time computing section 14a also checks by the management server data receiving section 41 if the data indicative of the modification of the terms of the contract is received from the management server 4, and computes the time for reissuing the password based on the result of checking. In the foregoing checking of the intervals for reissuing passwords, the time elapsed is checked as explained earlier. Specifically, the password is to reissued when a predetermined time has passed after the time of issuing the previous password. On the other hand, the utilization frequency is checked by comparing the utilization frequency for each receiving server with the reference value recorded in the data memory section 8. For example, it may be arranged so as to reissue a password when the utilization frequency exceeds the reference frequency. This reference value is also determined basically by the management server 4. For the modification in the basic terms of the contract, it may be arranged so as to reissue a password when the management server data receiving section 41 receives the data indicative of modifications in the basic terms of the contract from the management server 4. The password issue time computing section 14a may be arranged so as to set the time for reissuing the password to the time of detecting an illegal access from the exterior to the transmitting servers 6A to 6C based on an instruction give from the central processing section 9.

The subject user data acquiring section 14b checks the utilization frequency, an average transmission speed, a basic contract element, and an account settlement state for each of the receiving servers, and determines the discount rate explained earlier.

The password issue determining section 14c checks if the existing state of the client with regard to the data transmission satisfies the predetermined standards. Specifically, in the case of adopting the complete settlement of the account as the standard condition, those receiving servers which have not yet settled the account are determined to be disqualified for receiving updated passwords. As explained, the condition on the settlement of the account for the data communications may be adopted as the standard condition.

In the case where the number of communication errors is below the standard condition, the subject receiving server is determined to be disqualified for receiving updated passwords. As explained, the condition on the quality of the communications between the host computer and the computer of the client may be adopted as the standard condition.

As explained earlier, the password reflecting user data issuing section 14d prepares passwords reflecting the user data with respect to those receiving servers qualified for receiving reissued passwords as results of determination by the password issue determining section 14c.

The new password transmission/receiving controlling section 14e controls so as to send a new password reflecting user data prepared by the password reflecting user data issuing section 14d to the corresponding receiving server and also controls so as to perform the authentication check upon receiving the new password reflecting user data from the receiving server.

As explained earlier, the accounting management section 18 is a block for computing the accounting data with regard to the data transmission based on the user data or changing a charge per reproduction.

The data transmission management section 19 is a block for recording transmission data to be transmitted to the receiving server as log data, and for controlling the transmission of data to which a transmitting server ID is added.

The contract modification processing section 20 modifies the basic terms of the contract of the corresponding receiving server upon receiving the data indicative of the modifications in the basic terms of the contract from the management server 4, and controls the user data management section 44 to perform process of reissuing a password.

As explained earlier, the management server data receiving section 41 receives the data indicative of modifications in basic terms of contract, the PR campaign data and the user data received from the management server 4.

The user data management section 44 is a block for managing user data of each receiving server explained earlier and recording the corresponding file of the data memory section 8. The user data management section 44 also manages the ID and password data for each receiving server and records the corresponding file of the data memory section 8.

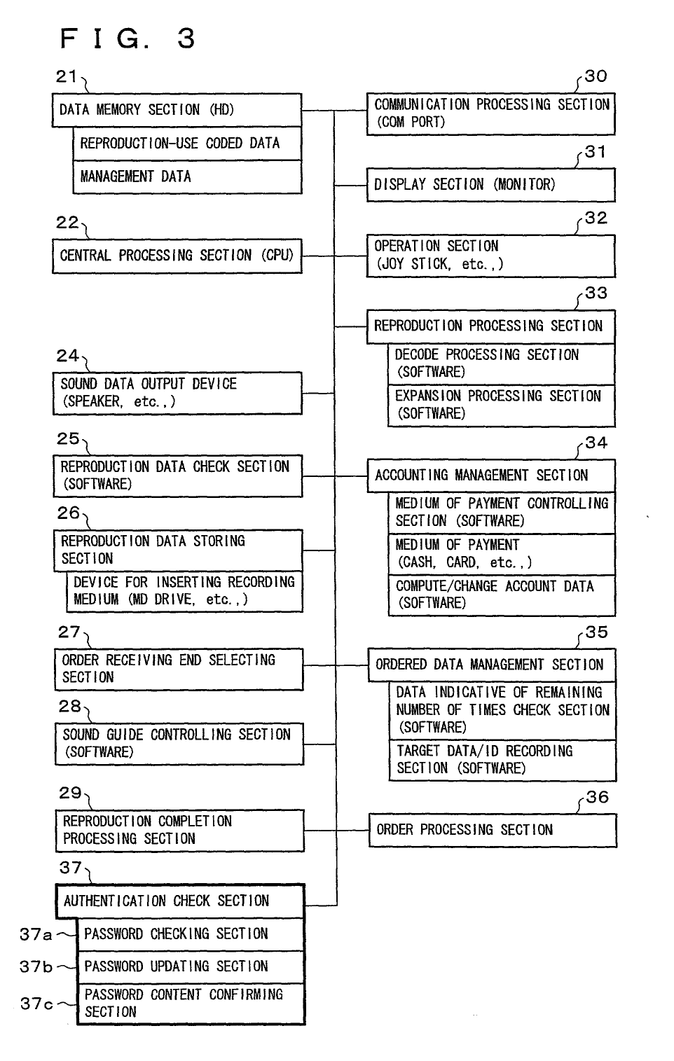

Next, the structure of the receiving servers 7A to 7C will be explained. FIG. 3 is a block diagram illustrating a schematic structure of the receiving servers 7A to 7C. FIG. 3 shows an example where the receiving servers 7A to 7C are constituted by the servers of PC base.

As illustrated in FIG. 3, each of the receiving servers 7A to 7C includes a data memory section 21, a central processing section 22, a sound data output device 24, a reproduction data check section 25, a reproduction data storing section 26, an order receiving end selecting section 27, a sound guide controlling section 28, a reproduction completion processing section 29, a communication processing section 30, a display section 31, an operation section 32, a reproduction processing section 33, an accounting management section 34, an ordered data management section 35, an order processing section 36 and an authentication check section 37.

In the example structure shown in FIG. 3, all the sections are connected in the same way. In practice; however, some sections are connected in hardware configuration via various buses and interfaces, etc., and the other sections are connected in software configurations by the linkage on a control/processing program. In the following explanations given for each configuration, transmitting servers 7A to 7C are referred to simply as a transmitting server.

The data memory section 21 is constituted by memory means such as a hard disk (HD) device. The data memory section 21 stores therein data to be transmitted, data indicative of the existing state of the receiving server with regard to the data transmission (such as utilization frequency, transmission speed, basic terms of contract, account settlement state, etc.), or various other management data with regard to transmission. In this hard disk device, or another hard disk device, stored are OS or various programs or data required for the operation of the transmitting server, and the hard disk device serves as a recording medium of the present invention.

The central processing section 22 is constituted by an arithmetic processing section such as CPU, and performs various arithmetic processing within the transmitting server. Although not shown, RAM, etc., required for performing various arithmetic processes may be provided.

The communication processing section 30 serves as an interface with a computer provided in the outside of the transmitting server, and a specific COM port is provided to the computer which constitutes the transmitting server. The network interface is not particularly specified, and, for example, Ethernet (registered trademark), FDDI, ISDN, ATM, etc., may be adopted as explained earlier for the transmitting servers.

The display section 31 is constituted by various display monitors such as CRT, LCD, etc. The operation section 32 is constituted by an input device such as a joy stick, a button, etc. The foregoing structure permits the user to purchase data as desired by an input operation using the operation section 32 while observing the display section 31.

The sound data output device 24, which is constituted by an amplifier section, a speaker, etc., is a block for outputting various sounds. For example, when purchasing music data, the sound data output device 24 generates sound of the music to be purchased, or outputs sounds for an operation guide, or BGM.

The above explained reproduction data storing section 26 is a block which performs an operation of recording some data onto the recording medium when the data is to be purchased by the consumer. The non-limited examples of the recording medium includes MD, CD-R, CD-RW, DVD-R, DVD-RW, DVD-RAM, IC memory, floppy disk, ZIP disk, MO, compact size hard disk, etc. The consumer may bring this recording medium to the place of the terminal equipment to record thereon data as desired. It may be also arranged such that the consumer can purchase the recording medium set beforehand in the terminal equipment with the additional payment for the recording medium in addition to the use fees for the data.

The above-explained data memory section 21, the central processing section 22, the sound data output device 24, the reproduction data storing section 26, the communication processing section 30, the display section 31 and the operation section 32 constitute a hardware configuration of the transmitting server. On the other hand, below-explained reproduction data check section 25, the order receiving end selecting section 27, the sound guide controlling section 28, the reproduction completion processing section 29, the reproduction processing section 33, the accounting management section 34, the ordered data management section 35, the order processing section 36, and the authentication check section 37 constitute a software configuration at the receiving server.

The reproduction data check section 25 is a block for checking data indicative of reproduced number of times of the specific data when the specific data subjected to the user's reproduction request is stored in the receiving server, and determines if the reproduction of the subject data is available. Here, if it the reproduction of the subject data is determined to be not available, the receiving server requests other available transmitting server to transmit the data.

The sound guide controlling section 28 is a block for controlling various sound guides with regard to the reproduction of data for the consumer.

The reproduction completion processing section 29 is a block for transmitting the record data to the management server 4 and for storing record data, upon completing the reproduction process with respect to the consumer.

The reproduction processing section 33 is a block for decoding encrypted data with respect to the data subjected to the reproduction request. In the case where the subject data is compressed data, the reproduction processing section 33 performs the process of decompressing (extending) the data at the same time. In this way, the reproduction processing section 33 converts the data subjected to reproduction request into the reproducible data format.

The accounting management section 34 is a block for managing accounts with regard to the reproduction request, i.e., the data purchase request made by the consumer. Non-limited examples of the medium of settlement include: cash, credit card, debit card, prepaid card, etc. The accounting management section 34 is provided with a cash collecting device or a device for settling an account by cards of various kinds, and a system for controlling these devices. The accounting management section 34 also has functions of computing the account data for the data transmitted based on the reproduced number of times or changing a charge for each reproduction of data.

The ordered data management section 35 is a block for checking the reproduced number of times of data stored in the receiving server and recording and managing the data together with its ID. With this ordered data management section 35, the remaining permissible number of times of reproduction for each data stored in the receiving server can be recognized.

The order processing section 36 is a block for making a request for transmitting the data with respect to the transmitting server, when the ordered data management section 35 determines the remaining permissible number of times of reproduction of the subject data is “0” or not more than the predetermined number.

The order receiving end selecting section 27 selects the communication server suited for processing data subjected to the transmission request in response to transmission request at the order processing section 36.

The authentication check section 37 is a characteristic block of the receiving server of the present invention. The basic function of the authentication check section 37 is to send ID and password to the transmitting server to confirm if the receiving server is authenticated. The authentication check section 37 includes a password checking section 37a, a password updating section 37b and a password content confirming section 37c to perform other functions than the above-explained basic functions respectively.

Upon receiving ID and password from the transmission receiver in contract, the password checking section 37a checks if the subject transmitting server is a regular transmitting server using ID and password, and permits the authenticated transmitting server to access.

The password updating section 37b performs a process of updating the password which had been effective until the undated new password is issued.

The password content confirming section 37c extracts from the new password the data to be incorporated into the password, composed of the user data and the PR campaign data, and reads the discount application ranking, classification data on subject data, maximum permissible number of times of reproduction and PR campaign data.

For example, when some modification is made on the discount application ranking, or the PR campaign data are included, the accounting management section 34 performs with a confirmation by the password content confirming section 37c, a process of changing an account chargeable to a consumer, or use fees of data payable to the owner of copyright. Further, when the classification data for the subject data indicative of changes in kinds or range of the available data, or data indicative of a change in the maximum permissible number of time of utilization is included, the ordered data management section 35 performs with a confirmation by the password content confirming section 37c, the process of changing the kinds and the range of available data as stored, or the process of modifying the recorded maximum permissible number of times of reproduction of the subject data.

As described, the receiving server reads the terms of contract by reading the password reflecting user data, and is therefore capable of immediately setting the process with regard to the data transmission in pursuance of the terms of the contract as read. According to the foregoing structure, the manager of the transmitting server and the manager of the receiving server can confirm each other the terms of the contract without difficulties, and the necessary procedures to be taken for both parities to perform in pursuance of the terms of the contract or to modify the terms of the contract can be simplified.

Lastly, the process of reissuing a password reflecting user data to be performed by the transmitting server will be explained in reference to the flowchart of FIG. 1.

For the process of updating the password, first, it is checked by the password issue time computing section 14a in STEP 1 (hereinafter referred to as S1) if it is a time for reissuing a renewed password. If it is determined in S1 that it is the time for reissuing a renewed password, the subject user data acquiring section 14b checks i) a data utilization frequency under the control by the user data management section 22 (S2), ii) an average data transmission speed (S3), iii) an account settlement state (S4), basic terms of a contract and also if any modification is made on the contract (S5), and a communication stability (S6). Then, the discount application ranking explained earlier is calculated in consideration of the results of the above checking.

Next, the password issue determining section 14c compares the user data with the standard condition (S7). Then, it is determined if the user data satisfies the standard condition by the password issue determining section 14c (S8). If it is determined that the user data does not satisfy the standard condition, the process of issuing password is terminated (S9), and further as this means that the receiving server is disqualified, for the purpose of preventing any future data transmission from being taken place with respect to the subject receiving server, the process of updating a password of the subject receiving server is performed (S10). In this way, the subject receiving server from now on can never be authorized by the transmitting server. Therefore, for example, such problem that the disqualified receiving server that has not settled the use fees, from keep receiving data illegally can be prevented, thereby realizing enhanced security of the transmitting server.

On the other hand, if it is determined in S8 that the user data satisfies the standard condition, the password reflecting user data issuing section 14d prepares a password reflecting the discount application ranking obtained by the subject user data acquiring section 14b or other user data and PR campaign data, performs a process of updating the recorded password with respect to the subject receiving server (S11).

Then, after the transmitting server is being authenticated by sending its password to the receiving server, the new password transmission/receiving controlling section 14e transmits a new password reflecting the user data to the subject receiving server in S12. Here, the authentication check section 10 authorizes the receiving server based on the previous password sent by the receiving server (S13). As a result of authentication check performed by the authentication check section 10 (S14), if the result of checking is negative, the process of issuing password is terminated (S15), and in the meantime, a process of investigating a cause of the negative result is performed as necessary such as retrying a certification check, or transmitting the negative result of authentication to the management server 4 (S16).

On the other hand, if the result of the authentication check is positive in S14, with a receipt of a new password, on the side of the receiving server, the previously used password of the receiving server is updated, and a process of registering the new password is performed. Then, the transmitting server waits for the receipt of the new password from the receiving server, and upon receiving the new password, the authentication check is performed by the authentication check section 10 based on the new password (S17). If the result of the authentication check based on the new password is negative, it is very likely that some error has occurred in the process of updating a password in the receiving server, and thus, for example, a message indicative of that the subject receiving server cannot be authenticated may be transmitted to the subject receiving server.

On the other hand, if the result of the authentication check based on new password is positive, completion data indicative of that the receiving server is authenticated successfully, and that new password has been issued successfully is transmitted by return mail to the receiving server (S18), thereby completing all the processes.

As described, according to the present invention, when a time to reissue a password has come, irrespectively of the accuracy of the receiving server, the password is always reissued by the transmitting server in S10 and S11. Therefore, even if the third person makes an attempt to steel the password, since the password has been changed already at the transmitting server, such problem that the third person keeps receiving data illegally until the steeling of the password is recognized can be prevented. As a result, enhanced security measures can be realized for both the transmitting server and the receiving server.

In the foregoing preferred embodiments, explanations have been given through the relationship between the transmitting server and the receiving server with regard to data communications; however, the present invention is not intended to be limited to the above relationship between the transmitting server and the receiving server. Namely, the present invention is applicable to any computer network including the host computer and the computer of the client which receives a password issued from the host computer.

For example, in the case where the secondary transmitting servers 2A, 2B and 2C and the tertiary transmitting servers 3A, 3B and 3C shown in FIG. 5 respectively issue and reissue passwords reflecting the user data from the management server 4, the transmitting server shown in FIG. 2 may be adopted for the management server 4, and the receiver server of FIG. 3 may be adopted for each of the secondary and tertiary transmitting servers 2A to 2C, and 3A to 3C.

Here, the respective processes to be performed by the transmitting server and the receiving server may be realized by a computer readable program stored in the recording medium. In the present invention, the recording medium may be memory (not shown) (ROM itself, for example), required for performing processes by the transmitting server and the receiving server, or a program media readable by inserting the recording medium into a program reading unit provided as an external memory unit (not shown).

In any of the above cases, it may be arranged so as to execute the program stored in the recording medium by an access of a microprocessor (not shown), or by reading the program from the recording medium and downloading the program as read into program memory areas not shown of the transmitting server and the receiving server. In the latter structure, the program to be downloaded is stored beforehand in the main body.

Here, the program media is a recording medium detachable from the main body, and may be a medium for storing a program in a fixed state, non-limited examples of which include a tape-shaped recording medium, such as a magnetic tape, a cassette tape, etc., a disk-shaped recording medium such as a floppy disk, a hard disk or other magnetic disk, or CD-ROM, MO, MD, DVD or other optical disk, card-shaped recording medium, such as IC card (including memory card, etc.), an optical card, etc., or a recording medium including a semiconductor memory such as mask ROM, EPROM, EEPROM, a flash ROM, etc.

The present invention has a system structure connectible to communication network including Internet, etc., and therefore, the program may be stored in a fluid state so that the program can be downloaded from the communication network. In the case of downloading the program from the communication network, the program to be downloaded may be stored in the main body or may be installed from other recording medium.

The program to be stored in the recording medium is not particularly limited, and, for example, a program in a data form may be adopted.

The password issuing device of the present invention which issues a password to be sent from the computer of a client for an authentication check thereof upon initiation of data transmission, may be arranged so as to include:

a data management section for recording beforehand terms of contract of the client with regard to data transmission; and

a password issuing section for issuing a password including specific data indicative of the terms of contract.

The host computer provided with the password issuing device is therefore capable of transmitting the terms of the contract with regard to data transmission to the client only by issuing the password to the computer of the client and carrying out the data communication process on the instant in pursuance of the terms of the contract.

The recording medium of the present invention may be arranged so as to be a computer readable recording medium storing a program for executing the data transmission method which is characterized by issuing a password for use in an authentication check of a computer of a client at a data receiving end including specific data indicative of the terms of the contract of the client with regard to data transmission.

The data transmission method of the present invention which includes the step of i) sending a password by a computer of a client at a receiving end of data with respect to a host computer at a transmitting end of data, to be authenticated by the host computer, may be arranged so as to include the step of:

i) receiving by the computer of the client the password including specific data indicative of the terms of contract of the client with regard to data transmission, as issued by the host computer;

ii) reading the specific data from the password as issued; and

iii) performing the terms of the contract as read.

As a result, the computer of the client can recognize the terms of the contract by reading the password issued from the host computer and immediately perform processes with regard to data transmission in pursuance of the terms of the contract as read.

The processes with regard to data transmission in pursuance of the terms of the contract include, for example, a process of automatically settling an account for use fees of data per use with respect to the transmitter of the data, or in the case where the computer of the client is an intermediate transmitter for downloading the data downloaded from the host computer into a computer of a third person, a process for restricting the number of transmission of data in pursuance of the terms of the contract, or changing the use fees of certain data for a prescribed period of time, etc.

When some modification is made in the terms of contract, only by reissuing a password including the specific data indicative of modified terms of contract, the host computer at the transmitting end of data can immediately instruct the computer of the client to change the setting of its processes with regard to the data transmission so as to reflect the modification in the terms of the contract.

As described, the present invention provides the data transmission system which realizes simplified yet reliable procedures required for making processes with regard to data transmission to be surely performed in pursuance of the terms of the contract, or for modifying the terms of the contract, etc., by mutually confirming the terms of the contract between the transmitting end and the receiving end of data, and performing these procedures mainly at the transmitting end.

As described, the password issuing method of the present invention issues a password including specific data indicative of the terms of contract set for the client with regard to data transmission in an agreement between the administrator of the host computer and the client.

According to the foregoing structure, it is possible for the computer of the client to recognize the terms of the contract by reading the password issued from the host computer and to immediately set the processes with regard to data transmission in pursuance of the terms of the contract.

On the side of the host computer at the transmitting end of data, when some modification is amide in the terms of contract, a password including the specific data indicative of the modified terms of contract can be reissued.

Non-limited examples of the terms of the contract include an accounting condition to be applied to the client, a condition indicative of the classification of the data that can be supplied to the client, a condition on restricted utilization of data that can be applied to the client, etc.

As described, the present invention provides the data transmission system which realizes simplified yet reliable procedures required for making processes with regard to data transmission to be surely performed in pursuance of the terms of the contract, or for modifying the terms of the contract, etc., by mutually confirming the terms of the contract between the administrator of the host computer and the client, and performing these procedures mainly at the transmitting end.

As described, the password issuing method of the present invention is arranged so as to include the steps of:

iii) comparing with predetermined standard condition, an existing state of the client with regard to data communications to be taken place at least between the host computer and the computer of the client, or between the computer of the client and a computer of a third person; and

iv) updating the specific data according to the result of comparison obtained in the step iii).

Non-limited examples of the predetermined condition includes a condition on a settlement of an account for the data transmission, a condition on a quality of the data transmission taken place between the host computer and the computer of the client, etc.

According to the foregoing structure, it is possible to reflect the existing state of the client with regard to data transmission into the password to be issued by the host computer at the transmitting end of data. Therefore, the present invention provides the data transmission system which realizes simplified yet reliable required for making processes with regard to data transmission to be surely performed in pursuance of the terms of the contract, or for modifying the terms of the contract reflecting changes in the existing state of the client if occurred, etc., by mutually confirming the terms of the contract according to the existing state of the client between the transmitting end and the receiving end of data.

Here, the existing state of the client with regard data transmission is specifically determined, for example, by the performance of the contract set with regard to the data transmission between the transmitting end and the receiving end of data (including an account settlement state for use fees of data, etc.), or communication environment such as transmission speed, etc. It is therefore possible for the host computer at the transmitting end of data to determine the level of satisfaction of the predetermined standard condition, and modifies the terms of the contract according to the level of satisfaction, and then performs a process of reflecting the terms of the contract as modified into the password.

As described, the password issuing method of present invention further includes the steps of:

a) checking an existing state of the client with regard to the data transmission; and

b) reissuing an updated password if the existing state of the client satisfies predetermined standard condition as a result of checking in the step a), while terminating a process of reissuing an updated password if the existing state of the client does not satisfy the predetermined standard condition as a result of checking in the step a).

According to the foregoing structure, when the password is to be reissued, the existing state of the client is checked with regard to data transmission, i.e., the qualification or the level of satisfaction of the client is determined based on, for example, the performance of the contract set with regard to the data transmission in an agreement between the transmitting end and the receiving end of data (including an account settlement state for the use fees of data, etc.), or communication environment such as transmission speed, etc., and the password is selectively reissued only for qualified client which satisfies the predetermined condition. Further, for disqualified client which does not satisfy the predetermined condition for reissuing the password, the process of reissuing a password can be terminated.

Thereafter, the client for which the process of issuing the password is terminated, as being determined to be disqualified can never be authorized, and therefore can never receive data transmission.

Further, when incorporating the foregoing structure into the previously explained structure of the invention explained, it is possible to modify the terms of the contract according to the existing state of the client and to issue the password reflecting the modification in the terms of the contract with respect to the qualified client. As a result, it is possible to promptly yet surely perform processes of checking the qualification of the client and modifying the terms of the contract.

With the foregoing structure, whether or not the data transmission itself is to be performed can be set automatically according to the qualification of the client mainly at the transmitting end of data, thereby realizing still more enhanced security measure at the transmitting end of data.

As described, the data transmission method of the present invention is arranged so as to include the steps of:

i) sending a password by a computer of a client at a receiving end of data with respect to a host computer at a transmitting end of data, to be authenticated by the host computer; and

ii) updating by the host computer the password of the computer of the client by receiving a password reissued from the host computer at predetermined time intervals set on a side of the transmitting end of data.

The data transmission method of the present invention may be defined by the method which includes the step of authenticating a computer of a client at a receiving end of data by a host computer at a transmitting end of data, based on a password received from the computer of the client, and which further includes the steps of:

a) monitoring by the host computer if it is a time for reissuing the password; and

b) if it is the time for reissuing the password, carrying out by the host computer a process of updating the password.

According to the foregoing structure, even without a request for reissuing a password or an ID from the computer of the client, the password can be changed by the host computer at appropriate time intervals. Therefore, after the password is changed at the host computer, the computer of the client can never be authenticated by the host computer unless receiving the password as changed.

Therefore, even if the third person makes an attempt to steel the password, since the password has been changed already at the host computer, such problem that the third person keeps receiving data illegally until the steeling of the password is recognized can be prevented. As a result, enhanced security measures can be realized for both the host computer and the computer of the client.

Further, by arranging such that upon receiving the password from the host computer, the computer of the client reads out from the password as issued the content of the specific data indicative of the terms of the contract set for the client with regard to data transmission and performs the terms of the contract as read, it is possible for the computer of the client to recognize the terms of the contract by reading the password as issued from the host computer and to set the processes with regard to the data transmission in pursuance of the terms of the contract immediately.

As described, the present invention provides the data transmission system which realizes simplified yet reliable procedures required for making processes with regard to data transmission to be surely performed in pursuance of the terms of the contract, or for modifying the terms of the contract, etc., by mutually confirming the terms of the contract between the transmitting end and the receiving end of data, and performing these procedures mainly at the transmitting end.

As described, the password issuing device of the present invention for issuing a password to be sent from a computer of a client for an authentication check thereof upon initiation of data transmission, is arranged such that:

a reissuing time computing section for computing a time for reissuing the password; and

a password issuing section which determines if it is a time for reissuing the password based on the reissuing time of the password as computed by the reissuing time computing section, and performs a process of updating the password if it is the time for reissuing the password.

According to the foregoing structure, the password issuing device such as the host computer for performing, for example, the data transmission calculates the reissue time at the reissue time computing section, and the password can be renewed by the password issuing section. Therefore, the same effects as achieved from the password issuing method of the present invention as explained earlier can be achieved.

As described, the password issuing device of the present invention is arranged such that the password issuing section issues a password including specific data indicative of terms of contract with regard to data communications, set between a manager of the host computer and the client.

According to the foregoing arrangement, the function and effect as explained earlier for the password issuing method can be achieved.

As described, the password issuing device having the foregoing structure of the present invention is arranged so as to further include:

a data management section for recording and managing data indicative of an existing state of the client with regard to data transmission set for the computer of the client or data transmission with a computer of a third party, and for recording beforehand standard condition to be compared with the existing state of the client,

wherein the password issuing section reads out the data indicative of the existing state of the client recorded by the data management section as well as the standard condition to be compared with the existing state of the client when the password is to be reissued, and updates the specific data according to a result of comparison between the existing state of the client and the standard condition.

According to the foregoing structure, the existing state of the client of the above content is recorded by the data management section. Here, the recording means is not particularly limited, and, the above existing state may be recorded automatically by the data management section by periodically transmitting the existing state from the computer of the client to the host computer. Other than the above recording means, the following arrangement may be adopted, wherein another computer equipped with a folder is provided for managing the existing state of the client, the computer of the client stores the data on the existing state in the folder, and further, the host computer collects the data on the existing state of the client from the folder to be recorded by the data management section.

As a result, the same function and effect as explained in the password issuing method of the present invention can be realized.

As described, the password issuing device of the present invention having the foregoing structure is arranged so as to further include:

a data management section for recording and managing data indicative of an existing state of the client regarding data transmission with respect to the computer of the client or an exchange of data with a computer of a third party, and for recording beforehand standard condition to be compared with the existing state of the client,

wherein the password issuing section performs a process of reissuing an updated password when the existing state of the client satisfies predetermined standard condition, while terminates a process of reissuing the updated password when the existing state of the client does not satisfy the standard condition.

As a result, the same function and effect as explained in the password issuing method of the present invention can be realized.

The program for executing the password issuing method, and the computer readable recording medium storing the program of the present invention are arranged such that:

a host computer monitors if it is a time for reissuing a password for use in an authentication check of a computer of a client upon initiation of communication with the computer of the client, and if it is the timing for reissuing the password, performs a process of updating the password.

According to the foregoing method, by reading out from the recording medium the program for executing the password issuing method by the host computer, the function and effect as explained earlier for the password issuing method can be achieved.

The program for executing the password issuing method, and the computer readable recording medium storing the program of the present invention is characterized in that:

a computer of a client at a receiving end of data receives a password for use in an authentication check thereof by a host computer at a transmitting end of data, which contains specific data indicative of terms of a contract set for the client with regard to data transmission, reads a content of the specific data from the password issued by the host computer, and performs the terms of the contract according to the content as read.

According to the foregoing method, the same function and effect explained earlier for the data transmission method can be achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claim.

What is claimed is:

1. A password issuing method for issuing a password by a host computer, which is to be transmitted from a computer of a client to said host computer to be authenticated by said host computer upon initiation of communications, comprising the steps of:
i) monitoring by said host computer if it is a time for reissuing the password; and
ii) if it is determined in said step i) that it is the time for reissuing the password, carrying out a process of updating the password.

2. The password issuing method according to claim 1, wherein:
said password includes specific data indicative of terms of contract with regard to data communications set between an administrator of said host computer and the client.

3. The password issuing method, according to claim 2, wherein:
said terms of contract include an accounting condition applied to the client.

4. The password issuing method, according to claim 2, wherein:
said terms of contract include a condition on a classification of data that can be supplied to the client.

5. The password issuing method, according to claim 2, wherein:
said terms of contract include a condition on a restricted utilization of data that can be supplied to the client.

6. The password issuing method, according to claim 2, further comprising the steps of:
iii) comparing with predetermined standard condition, an existing state of the client with regard to data communications to be taken place at least between said host computer and said computer of the client, or between said computer of the client and a computer of a third person; and
iv) updating the specific data according to the result of comparison obtained in said step iii).

7. The password issuing method, according to claim 6, wherein:
said predetermined standard condition includes a condition on a settlement of an account for the data communications.

8. The password issuing method, according to claim 6, wherein:
the standard condition includes a condition on a quality of the data communications taken place between said host computer and said computer of the client.

9. The password issuing method, according to claim 1, further comprising the steps of:
a) checking an existing state of the client with regard to the data transmission; and
b) reissuing an updated password if the existing state of the client satisfies predetermined standard condition as a result of checking in said step a), while terminating a process of reissuing an updated password if the existing state of the client does not satisfy the predetermined standard condition as a result of checking in said step a).

10. A data transmission method, comprising the steps of:
i) sending a password by a computer of a client at a receiving end of data with respect to a host computer at a transmitting end of data, to be authenticated by said host computer; and
ii) updating by said host computer the password of said computer of the client by receiving a password reissued from said host computer at predetermined time intervals set on a side of the transmitting end of data.

11. A data transmission method, comprising the steps of:
a) authenticating a computer of a client at a receiving end of data by a host computer at a transmitting end of data, based on a password received from said computer of the client;
b) monitoring by said host computer if it is a time for reissuing the password; and
c) if it is the timing for reissuing the password, carrying out by said host computer a process of updating the password.

12. A password issuing device for issuing a password to be sent from a computer of a client for an authentication check thereof upon initiation of data communications, comprising:
a reissuing time computing section for computing a time for reissuing the password; and
a password issuing section which determines if it is a time for reissuing the password based on the reissue time of the password as computed by said reissue time computing section, and performs a process of updating the password if it is the time for reissuing the password.

13. The password issuing device according to claim 12, wherein:
said password issuing section issues a password including specific data indicative of terms of contract with regard to data communications, set between a manager of said host computer and the client.

14. The password issuing device according to claim 13, further comprising:
a data management section for recording and managing data indicative of an existing state of the client regarding data transmission with respect to said computer of the client or data transmission with a computer of a third party, and for recording beforehand standard condition to be compared with the existing state of the client,
wherein said password issuing section reads out the data indicative of the existing state of the client recorded by said data management section as well as the standard condition to be compared with the existing state of the client when the password is to be reissued, and updates said specific data according to a result of comparison between the existing state of the client and the standard condition.

15. The password issuing device according to claim 12, further comprising:
a data management section for recording and managing data indicative of an existing state of the client regarding data transmission with respect to said computer of the client or an exchange of data with a computer of a third party, and for recording beforehand standard condition to be compared with the existing state of the client,
wherein said password issuing section performs a process of reissuing an updated password when the existing state of the client satisfies predetermined standard condition, while terminates a process of reissuing the updated password when the existing state of the client does not satisfy the standard condition.

16. A program for executing a password issuing method, wherein:
a host computer monitors if it is a time for reissuing a password for use in an authentication check of a computer of a client upon initiation of communication with said computer of the client; and if it is the timing for reissuing the password, performs a process of updating the password.

17. A computer readable recording medium storing said program for executing said password issuing method of claim 16.

18. A program for executing a data transmission method, wherein:
a computer of a client at a receiving end of data receives a password to be authenticated by a host computer at a transmitting end of data, which contains specific data indicative of terms of a contract with the client with regard to data transmission, reads a content of the specific data from the password issued by said host computer, and performs the terms of the contract according to the content as read.

19. A computer readable recording medium storing said program for executing said data transmission method of claim 18.
